(19) United States
(12) Patent Application Publication
(10) Pub. No.: US 2009/0196250 A1
(43) Pub. Date: Aug. 6, 2009

(54) METHOD AND SYSTEM FOR ALLOCATING CHANNEL MEASUREMENT RESOURCES IN WIRELESS BROADBAND ACCESS

(75) Inventors: Shulan Feng, Shenzhen (CN); Jinnan Liu, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/421,727

(22) Filed: Apr. 10, 2009

Related U.S. Application Data
(63) Continuation of application No. PCT/CN2008/070388, filed on Feb. 29, 2008.

(30) Foreign Application Priority Data
Mar. 9, 2007 (CN) 200710088034.0
Apr. 29, 2007 (CN) 200710103012.7

(51) Int. Cl. H04W 72/00

(52) U.S. Cl. 370/330

(57) ABSTRACT

A method for allocating resource of channel measurement in wireless broadband access includes the following steps. A subscriber station receives a channel measurement request which includes a channel to be measured and a measurement time from a base station, and performs a measurement on the channel to be measured within the measurement time. A system, a base station, and a subscriber station in wireless broadband access are also provided in the embodiments of the invention. The embodiments of the invention enable the subscriber station to acquire the available measurement resource while maintaining normal service and communication with the serving base station.

### CROSS-REFERENCE TO RELATED APPLICATIONS

This application is a continuation of International Patent Application No. PCT/CN2008/070388, filed Feb. 29, 2008, which claims priority to Chinese Patent Application No. 200710088034.0, filed Mar. 9, 2007, and Chinese Patent Application No. 200710103012.7, filed Apr. 29, 2007, all of which are hereby incorporated by reference in their entirety.

### FIELD OF THE INVENTION

The present invention relates to a technical field of wireless broadband access, in particular, to a method and system for allocating channel measurement resources in wireless broadband access.

### BACKGROUND

The broadband wireless access technology may be classified into two types based on the adopted frequency band, namely a high-band LMDS system and a low-band MMDS system. Different countries have different divisions for the frequency band. The former one usually occupies the frequency band such as 26 GHz, 28 GHz, 36 GHz, and 38 GHz, and the latter one occupies the lower frequency band such as 2.5 GHz, 3.5 GHz, 5.8 GHz, and 10.5 GHz. The LMDS system is characterized by a larger available bandwidth, but the all-weather coverage is generally in an area within 5 km, which is adapted for central business districts. The MMDS system is seldom influenced by the rain, and the all-weather coverage thereof is generally in an area of 10 km above, but the bandwidth is smaller, which is adapted for SME and SOHO users.

The broadband wireless access system usually includes a base station (BS), a subscriber station (SS), and an element management system (EMS). The base station is responsible for covering the subscriber station, and providing various service interfaces to the core network. The subscriber station includes an outdoor unit and an indoor unit, and usually adopts an outdoor directional antenna of a small aperture. The indoor unit may provide various user interfaces. Element management system (EMS) is connected to the base station. The manners of the EMS include inband EMS, outband EMS, and local EMS, so as to realize the functions of operation maintenance, performance monitoring, and software download for the system.

Due to the complex environment of the wireless communication system, in order to maintain the communication quality, the status of wireless channel needs to be detected in a real time, and adjusted according to the characteristic of the wireless channel. Measurement is even more important to wireless equipments adopting cognitive radio technology. The correct decision on the environment is made only based on the reliable measurement information, and thus maintaining the good communication quality and prevent the interference with other systems.

Many efforts are made to improve the effectiveness and robustness of an unlicensed system, so as to achieve the coexistence among the unlicensed systems, and the unlicensed system and the licensed system. Currently, two coexistence mechanisms are defined: the coordinated coexistence and the uncoordinated coexistence. In the coordinated coexistence mechanism, different systems need coordination to maintain the good communication quality and prevent the interference. The uncoordinated coexistence mechanism may be realized in two ways. One approach is performing a carrier sense before the transmission of signals, in which if a signal transmission is detected, the transmission of signals will not be performed, so as to avoid the interference. The other approach is actively rendering some resources when in the situation that multiple systems share the same channel. For the uncoordinated coexistence mechanism, normally, there is no inter-system communication.

In order to achieve the better coexistence, various measurement requirements are defined. For the uncoordinated coexistence, some silent frames are defined for performing the measurement, or a certain time slot is allocated at a certain frame for measurement. However, the inventor finds that, in the absence of the silent frames, the specific time at which the measurement is performed has not been defined, and the approach of allocating measurement time for each frame may cause the deficiencies of a high load for the signaling of the system and a low efficiency.

### SUMMARY

Embodiments of the present invention provide a method for allocating resource of channel measurement, adapted to allocate measurement resource for a subscriber station having been in the network.

Embodiments of the present invention also provide a system for allocating resource of channel measurement, adapted to allocate measurement resource for a subscriber station having been in the network.

In order to achieve the above objectives, the technical solution of the present invention is realized as follows.

The method for allocating resource of channel measurement in wireless broadband access includes the following steps.

A subscriber station receives a channel measurement request which includes a channel to be measured and a measurement time from a base station, and performs a measurement on the channel to be measured within the measurement time.

When the channel to be measured is the working channel, the method includes the subscriber station receiving the channel measurement request, and performing a measurement on the working channel within the measurement time.

The measurement on the working channel includes the measurement on licensed user(s) or unlicensed user(s) associated to the non-serving base station.

When the channel to be measured is a non-working channel, the method includes the following steps.

Within the measurement time, the subscriber station is switched from the working channel to the non-working channel.

The subscriber station performs a measurement on the non-working channel.

The method further includes pre-setting a maximum channel switching time.

In the method, the subscriber station starts the measurement on the non-working channel no later than the maximum channel switching time after the start of the measurement time, and terminates the measurement on the non-working channel no later than the maximum channel switching time before the end of the measurement interval.

The method further includes the subscriber station reporting a measurement result to the base station.

The step of the subscriber station reporting the measurement result to the base station includes the following steps.

The subscriber station reports actively the measurement result to the base station after the measurement is terminated without requested from the base station; or

The subscriber station reports actively the measurement result to the base station before the measurement is terminated without requested from the base station; or

Before the subscriber station terminates the measurement, the base station transmits a measurement result report request to the subscriber station, and the subscriber station reports the measurement result to the base station in response to the measurement result report request; or

After the subscriber station terminates the measurement, the base station transmits a measurement result report request to the subscriber station, and the subscriber station reports the measurement result to the base station in response to the measurement result report request.

The method further includes the subscriber station terminating the measurement on the channel to be measured.

The step of the subscriber station terminating the measurement on the channel to be measured includes the following steps.

The base station transmits a measurement termination request to the subscriber station, and the subscriber station terminates the measurement in response to the measurement termination request; or

The base station instructs the subscriber station to receive a downlink signal or transmit an uplink signal within the measurement time, and the subscriber station terminates the measurement.

The measurement time is preset according to a measurement purpose of the base station and traffic of the subscriber station.

The method further includes the following steps.

The subscriber station performs a normal communication with the base station outside the measurement time, and the set measurement time has no impact on the normal communication between the subscriber station and the base station.

The measurement time is set within a specific sub frame period or a specific time slot.

The specific sub frame is a slave sub frame.

The specific time slot is a CSI time slot, a CMI time slot, or a CXCC time slot.

The measurement time is periodical interval.

The measurement time includes a measurement start frame, a start position and a termination position of measurement time-frequency block, measurement duration, and an interval between successive measurement frames. If the termination position of the measurement time-frequency block is not defined, the default termination position of the measurement time-frequency block is the end of a frame containing the measurement time-frequency block.

The method further includes any one or any combination of more than one selected from among adopting a high-order modulation, reducing an encoding rate, enhancing a transmit power, and increasing allocated time-frequency resources.

The subscriber station receives one or more measurement request(s) from the base station.

When reporting the measurement result, the subscriber station indicates that which measurement result is related to which measurement request of the base station.

The measurement time in all the measurement requests of the same base station is not overlapped.

The channel measurement request received by the subscriber station further includes a channel measurement request index numbered by the base station.

When reporting the measurement result, the subscriber station further reports the measurement request index corresponding to the measurement result to the base station.

The base station allocates measurement resource to multiple subscriber stations at one time, the channel measurement requests of multiple subscriber stations are encapsulated into one request message, and the measurement request of each subscriber station includes one or more measurement resource allocation scheme(s).

The system for allocating resource of channel measurement in wireless broadband access system includes a base station and a subscriber station.

The base station is adapted to transmit a channel measurement request to the subscriber station which includes a channel to be measured and a measurement time.

The subscriber station is adapted to receive the channel measurement request, and perform a measurement on the channel to be measured within the measurement time.

The base station is adapted to set the measurement time according to a measurement purpose and a traffic of the subscriber station, and transmit the channel measurement request including the channel to be measured and the measurement time to the subscriber station.

Within the measurement time, the base station does not send downlink signal to the subscriber station, or receive any uplink signal from the subscriber station.

The subscriber station performs a normal communication with the base station outside the measurement time, and the set measurement time has no impact on the normal communication between the base station and the subscriber station.

The subscriber station further reports the measurement result to the base station.

The subscriber station is adapted to report actively the measurement result to the base station after the measurement is terminated without the request of base station; or

The subscriber station is adapted to report actively the measurement result to the base station before the measurement is terminated without the request of base station; or

Before the subscriber station terminates the measurement, the base station transmits a measurement result report request to the subscriber station, and the subscriber station reports the measurement result to the base station in response to the measurement result report request; or

After the subscriber station terminates the measurement, the base station transmits a measurement result report request to the subscriber station, and the subscriber station reports the measurement result to the base station in response to the measurement result report request.

The wireless broadband access system is an IEEE 802.16 system or an IEEE 802.22 system.

The base station in wireless broadband access includes a measurement time setting unit and a channel measurement request transmitting unit.

The measurement time setting unit is adapted to set the measurement time during which the subscriber station performs a measurement on the channel according to a measurement purpose and a traffic of the subscriber station.

The channel measurement request transmitting unit is adapted to transmit the measurement time set by the measurement time setting unit.

The base station further includes a measurement result receiving unit adapted to receive the measurement result reported by the subscriber station.

The channel measurement request transmitting unit is further adapted to transmit the measurement termination request to the subscriber station.

The subscriber station in wireless broadband access includes a channel measurement request receiving unit and a channel measurement unit.

The channel measurement request receiving unit is adapted to receive a channel measurement request which includes a channel to be measured and a measurement time; and

The channel measurement unit is adapted to perform a measurement on the channel to be measured within the measurement time.

The channel to be measured is a working channel.

The channel measurement unit is adapted to perform a measurement on the working channel within the measurement time.

The channel to be measured is a non-working channel.

The channel measurement unit is adapted to switch the subscriber station from the working channel to the non-working channel, and perform a measurement on the non-working channel within the measurement time.

The subscriber station further includes a measurement result reporting unit.

The measurement result reporting unit is adapted to report the measurement result measured within the measurement time to the base station.

It can be known from the above technical solution that in some embodiments of the present invention, the base station transmits a channel measurement request which includes a channel to be measured and a measurement time to the subscriber station. The subscriber station receives the channel measurement request, performs a measurement on the channel to be measured within the measurement time, and preferably reports the measurement result to the base station. Based on the above, when requesting the subscriber station to perform a measurement, the base station may allocate a specific measurement resource to the subscriber station according to the measurement purpose and the traffic situation of the subscriber station. Moreover, the base station does not receive a downlink signal or transmit an uplink signal within the measurement time, thereby producing no affects on the operation of the normal service.

### BRIEF DESCRIPTION OF THE DRAWINGS

FIG. 1 is a schematic diagram of an exemplary flow of processes of a method for allocating resource of channel measurement in wireless broadband access, according to an embodiment of the present invention;

FIG. 2 is a schematic diagram of an exemplary frame of a measurement performed in a specific sub frame period, according to an embodiment of the present invention;

FIG. 3 is a schematic diagram of an exemplary frame of a measurement in a specific time slot, according to an embodiment of the present invention;

FIG. 4 is a schematic diagram of an exemplary frame of a measurement time of a subscriber station made by a base station, according to an embodiment of the present invention;

FIG. 5 is a schematic diagram of an exemplary structure of a system for allocating resource of channel measurement in wireless broadband access, according to an embodiment of the present invention;

FIG. 6 is a schematic diagram of an exemplary structure of the base station, according to an embodiment of the present invention; and

FIG. 7 is a schematic diagram of an exemplary structure of the subscriber station, according to an embodiment of the present invention.

### DETAILED DESCRIPTION

In order to make the aforementioned and other objectives, technical solutions, and advantages of the present invention more comprehensible, preferred embodiments accompanied with the drawings are described in detail below.

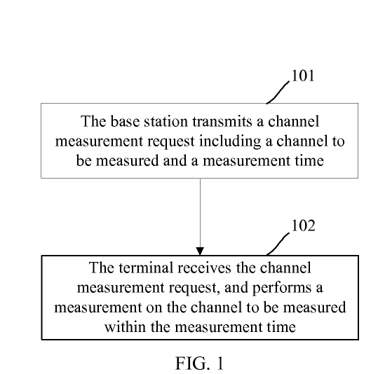

FIG. 1 is a schematic diagram of an exemplary flow of processes of a method for allocating resource of channel measurement in wireless broadband access according to an embodiment of the present invention.

As shown in FIG. 1, the method includes the following steps.

In Step 101, a base station transmits a channel measurement request to a subscriber station, and the channel measurement request contains a channel to be measured and a measurement time.

When requesting the subscriber station to perform a measurement, the base station may preferably allocate the specific measurement time (i.e., measurement resource) for the subscriber station according to the measurement purpose and the traffic of the subscriber station. In the preset measurement resource, the base station preferably neither transmits a downlink signal to the subscriber station, nor allocates an uplink transmission resource to the subscriber station. In addition, the base station allocates the measurement resource preferably without affecting the normal quality of service (QoS) between the base station and the subscriber station.

In the present invention, in order to guarantee the measurement without affecting the QoS of the normal service, the measurement may also be performed in a manner of, for example, a high-order modulation, reducing an encoding rate, enhancing a transmit power, and increasing allocated time-frequency resources, thereby ensuring the QoS.

In Step 102, the subscriber station receives the channel measurement request, and performs a measurement on the channel to be measured within the measurement time.

If the channel to be measured is a working channel, the subscriber station receives the channel measurement request, and performs the measurement on the working channel within the measurement time. Preferably, the measurement on the current working channel may include performing detection on the licensed user(s) or on the unlicensed user(s) of a non-serving base station.

If the channel to be measured is a non-working channel, within the measurement time, the subscriber station is first switched from the working channel to the non-working channel, and then performs the measurement on the non-working channel. The subscriber station is required to start the measurement on the non-working channel no later than the set maximum channel switching time after the start of the measurement time, and meanwhile terminate the measurement on the non-working channel no later than the set maximum channel switching time before the end of the measurement interval.

In the above flow, the subscriber station may further report the measurement result to the base station.

In detail, the subscriber station may actively report the measurement result to the base station after the measurement is terminated without the request from the base station. The subscriber station may also actively report the measurement result to the base station without the request from the base station before the measurement is terminated. Or, before the subscriber station terminates the measurement, the base station transmits a measurement result report request to the subscriber station, and the subscriber station reports the measurement result to the base station in response to the measurement result report request. Or, after the subscriber station terminates the measurement, the base station transmits a measurement result report request to the subscriber station, and the subscriber station reports the measurement result to the base station in response to the measurement result report request.

In the above flow, the base station may further terminate the measurement of the subscriber station.

In detail, before the measurement of the subscriber station is terminated, the base station may terminate the measurement of the subscriber station in an explicit manner. That is, the base station transmits a measurement termination request to the subscriber station, and the subscriber station terminates the currently-performed channel measurement after receiving the measurement termination request of the base station. The base station may request the subscriber station to report the current measurement result to the base station, or inform the subscriber station of discarding the measurement result. The base station may also terminate the measurement of the subscriber station in an implied manner. For example, the base station requests the subscriber station to receive the downlink signal or transmit the uplink signal in the originally allocated measurement resource, so as to terminate the measurement of the subscriber station.

Moreover, the base station may also transmit a new measurement request signal to terminate the currently-performed measurement. After the subscriber station receives the new measurement request, the subscriber station performs the measurement according to new measurement request, and the unfinished measurement result may be reported to the base station, or discarded. Whether to report or discard the unfinished measurement result may be determined by the base station's request.

If the base station has no request on whether to report the unfinished measurement result, the subscriber station may actively choose to report or not report the measurement result according to the situation of the measurement.

Moreover, the base station may transmit one or more measurement request(s) to the subscriber station. When the base station transmits multiple measurement requests to the subscriber station, the measurement time allocated in each measurement request is not overlapped. When reporting the measurement result, the subscriber station needs to indicate that which measurement result is related to which measurement request of the base station. The base station may number the measurement request, and transmits the measurement request index to the subscriber station together with the measurement request message. When reporting the measurement result, the subscriber station also reports the measurement request index which indicated the relationship between the measurement request and measurement result.

Further, the base station may also allocate the measurement resource for multiple subscriber stations at one time. Meanwhile, one request message may include measurement requests of multiple subscriber stations, and the measurement request of each subscriber station may include one or more measurement resource allocation scheme(s).

The measurement of the present invention includes any measurement, such as search of a specific signal, energy detection, and interference detection.

In the present invention, the measurement time is preferably preset by the base station according to the measurement purpose and the traffic of the subscriber station.

The base station may request the subscriber station to measure a non-working channel within a specific sub frame period (such as a slave sub frame period). In this case, within the requested measurement sub frame period, the base station may neither transmit a downlink signal to the subscriber station, nor request the subscriber station to transmit an uplink signal.

The base station may allocate the requested measurement time in various ways. For example, the base station usually informs by signaling the subscriber station to performs the measurement on the current frame, or the next frame, or the next N frame, and informs which sub frame or multiple sub frames are used for the measurement. The base station may also allocate a longer periodical measurement resource for the subscriber station. The base station may inform the subscriber station of the measurement duration in which the subscriber station keeps the measurement on the channel to be measured according to the allocated periodical measurement time until the base station updates the measurement requests in a certain way.

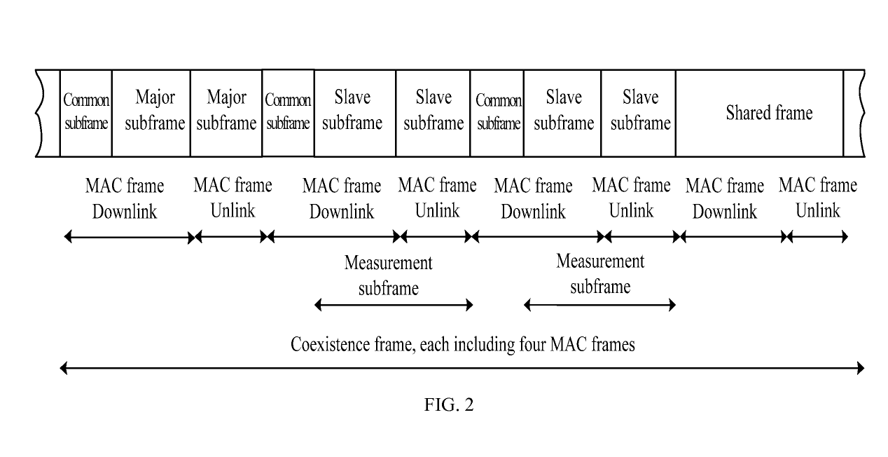

The base station may define the measurement time through transmitting the following parameters to the subscriber station. The parameters of one way for defining the measurement time include a measurement start frame, measurement duration, an interval between two successive measurement frames including a measurement sub frame, and a measurement sub frame. The measurement start frame defines a coexistence frame number of the start of the measurement or a measurement start frame number. The measurement duration defines the length of the measurement time, in which if the duration is a special value such as 0, it indicates that the measurement is kept performing in this way until the base station terminates the measurement in a certain manner. The interval between two successive measurement frames indicates that a MAC frame interval or coexistence frame interval between measurement frames including a measurement time-frequency block, that is the measurement sub frame. The measurement sub frame illustrates the specific subframe during which the measurement is performed, and one measurement frame may include one or more measurement sub frame(s). FIG. 2 is a schematic view of an exemplary frame of a measurement performed in a specific sub frame period, according to an embodiment of the present invention. As shown in FIG. 2, one coexistence frame includes 4 MAC frames, and the sub frame is a measurement sub frame.

The base station may also request the subscriber station to perform measurement in some specific time slots, such as CSI (Coexistence Signaling Interval)/CMI (Coexistence Massage Interval)/CXCC (Co-existence Control Channel). If the base station requests the subscriber station to measure the CSI/CMI/CXCC of the non-working channel, the base station may allocate the resource in a reasonable way, so as to reserve enough time for channel switching without affecting the normal communication.

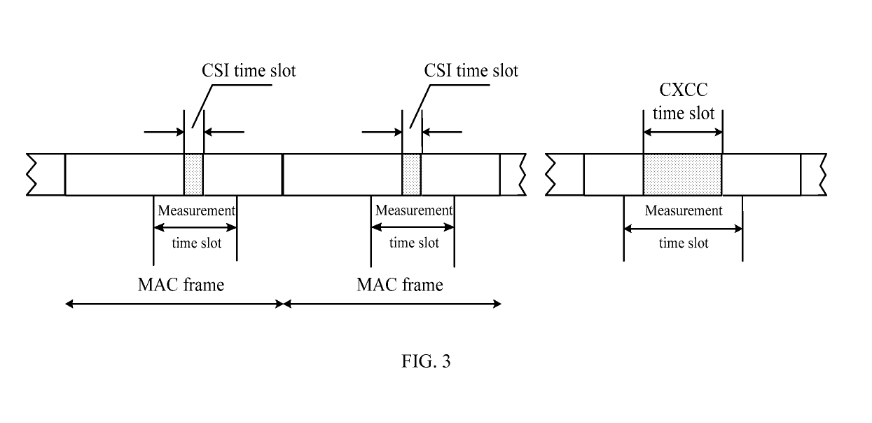

FIG. 3 is a schematic view of an exemplary frame of a measurement performed in a specific time slot according to an embodiment of the present invention. As shown in FIG. 3, the base station may inform the subscriber station of the measurement duration in which the subscriber station keeps measuring the channel to be measured in the CSI/CMI/CXCC time slot until the base station informs the subscriber station of updating the measurement request in a certain way. The base station may also inform of the channel to be measured within the time slot through the common signaling.

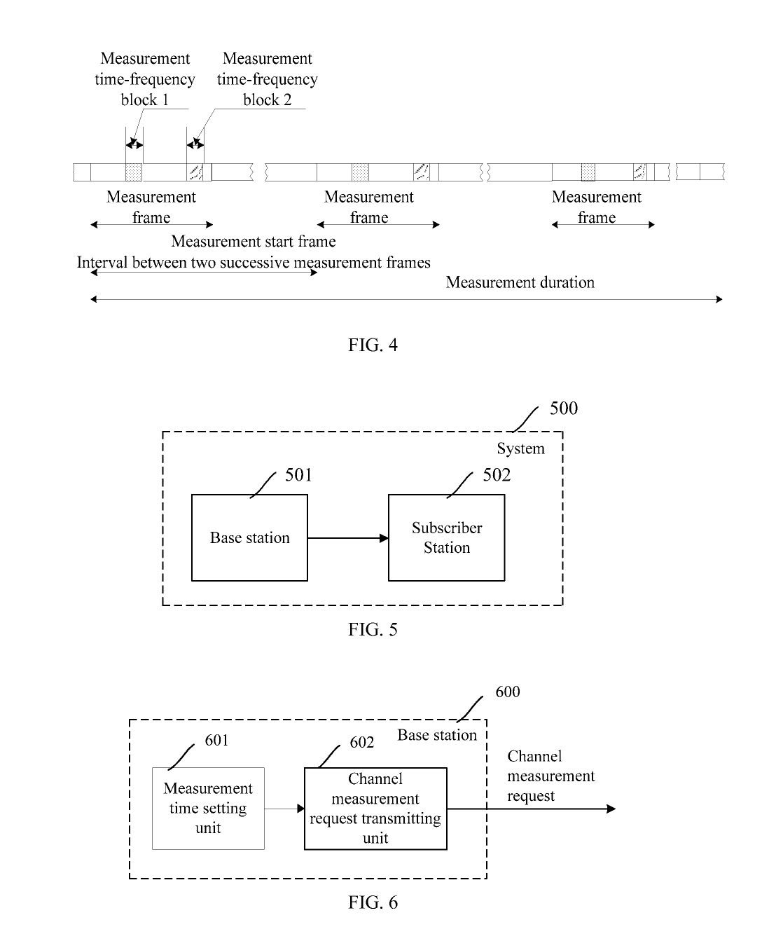

Or, the base station may also inform of a periodical measurement resource for the measurement in duration. FIG. 4 is a schematic view of an exemplary frame of a measurement time of subscriber station made by the base station, according to an embodiment of the present invention. First, the following parameters are defined. A measurement start frame defines the start frame number of measurement. A measurement duration defines the length of measurement time, in which if the duration is a special value such as 0, it indicates that the measurement is kept performing in this way until the base station terminates the measurement in various ways. An interval between two successive measurement frames indicates the number of frames between the successive measurement frames which includes the measurement time-frequency block. The measurement time-frequency block in each measurement frame is defined by the start position of the time-frequency block and a termination position of a time-frequency block. If the termination position of the time-frequency block is not defined, the default termination position of the time-frequency block is the end of the current frame. The measurement frame is the frame which includes the measurement interval, that is, measurement time-frequency block. One measurement frame may include one or more measurement the time-frequency block(s).

In general, the base station may accurately define the measurement time of the subscriber station. The method for defining includes, for example, defining the measurement start frame and the measurement interval. If the measurement start frame is 0, the measurement is performed on the current frame. If the measurement start frame is 1, the measurement is performed on the next frame, and so forth. The measurement interval is the time-frequency block used for the measurement in the measurement frame, and one or more measurement time-frequency block(s) may be included in one frame.

The present invention further provides a system for allocating resource of channel measurement in wireless broadband access system.

FIG. 5 is a schematic view of an exemplary structure of a system for allocating resource of channel measurement in wireless broadband access according to an embodiment of the present invention.

As shown in FIG. 5, the system 500 includes a base station 501 and a subscriber station 502.

The base station 501 is adapted to transmit a channel measurement request to the subscriber station 502, and the channel measurement request includes a channel to be measured and a measurement time.

The subscriber station 502 is adapted to receive the channel measurement request and perform a measurement on the channel to be measured within the measurement time.

Preferably, the base station 501 is adapted to set the measurement time according to the measurement purpose and the traffic of the subscriber station, and transmit a channel measurement request including a channel to be measured and measurement duration to the subscriber station 502.

The base station 501 does not transmit downlink signal to the requested subscriber station, or receive any uplink signal from the subscriber station within the measurement time. The base station 501 may perform normal communication with the subscriber station 502 outside the measurement time without affecting the normal service transmission of the subscriber station 502.

The subscriber station 502 is further adapted to report the measurement result to the base station 501. The subscriber station 502 may report actively the measurement result to the base station after the measurement is terminated without the request from the base station, or report actively the measurement result to the base station before the measurement is terminated without the request from the base station. Or, before the measurement of the subscriber station is terminated, the base station 501 transmits a measurement result report request to the subscriber station 502, and the subscriber station 502 reports the measurement result to the base station 501 in response to the measurement result report request. Or, after the measurement of the subscriber station is terminated, the base station 501 transmits a measurement result report request to the subscriber station 502, and the subscriber station 502 reports the measurement result to the base station 501 in response to the measurement result report request.

Preferably, the base station 501 may further terminate the measurement of the subscriber station 502.

In detail, before the measurement of the subscriber station 502 is terminated, the base station 501 may terminate the measurement of the subscriber station 502 in an explicit way. That is, the base station 501 transmits a measurement termination request to the subscriber station 502, and the subscriber station 502 terminates the channel measurement after receiving the measurement termination request of the base station 501. The base station 501 may request the subscriber station 502 to report the measurement result to the base station 501, or inform the subscriber station 502 of discarding the measurement result.

Moreover, the base station 501 may also terminate the measurement of the subscriber station 502 in an implied manner. For example, the base station 501 may request the subscriber station 502 to receive the downlink signal or transmit the uplink signal in the originally allocated measurement resource, so as to terminate the measurement of the subscriber station 502.

The base station 501 may also terminate the currently-performed measurement by transmitting a new measurement request. After receiving the new measurement request, the subscriber station 502 performs the measurement according to new measurement requirements, and the unfinished measurement result may also be reported to the base station 501, or discarded. Whether to report or discard the unfinished measurement result may be determined by the base station's request.

Preferably, the base station 501 may also transmit one or more measurement request(s) to the subscriber station 502. When the base station 501 transmits multiple channel measurement requests to the subscriber station 502, the measurement time allocated in each measurement request is not overlapped. When reporting the measurement result, the subscriber station 502 is required to indicate that which channel measurement is related to which channel measurement request of the base station 501.

Preferably, the base station 501 may number the measurement request, and transmit the measurement request index to the subscriber station 502 together with the measurement request message. When reporting the measurement result, the subscriber station 502 reports the measurement request index which indicates the relationship between the measurement report and the measurement result.

Preferably, the base station 501 may also allocate the measurement resource for multiple subscriber stations at one time. One request message may include measurement requests of multiple subscriber stations, and the measurement request of each subscriber station may include one or more measurement resource allocation scheme(s).

Preferably, the wireless broadband access system is an IEEE 802.16 system or an IEEE 802.22 system.

Although the IEEE 802.16 system and the IEEE 802.22 system are described by way of example for illustrating the present invention, persons skilled in the art should know that the present invention is not limited to the IEEE 802.16 system or the IEEE 802.22 system, and is adapted to any wireless broadband access system.

The present invention further provides a base station in wireless broadband access. FIG. 6 is a schematic view of an exemplary structure of the base station, according to an embodiment of the present invention.

As shown in FIG. 6, the base station 600 includes a measurement time setting unit 601 and a channel measurement request transmitting unit 602. The measurement time setting unit 601 is adapted to set the measurement time for the channel measurement of the subscriber station according to the measurement purpose and the traffic situation of the subscriber station. The channel measurement request transmitting unit 602 is adapted to transmit the measurement time set by the measurement time setting unit.

The channel measurement request transmitting unit 602 may be further adapted to transmit a measurement termination request to the subscriber station, and the subscriber station terminates the measurement in response to the measurement termination request.

The base station 600 may further include a measurement result receiving unit adapted to receive the measurement result reported by the subscriber station.

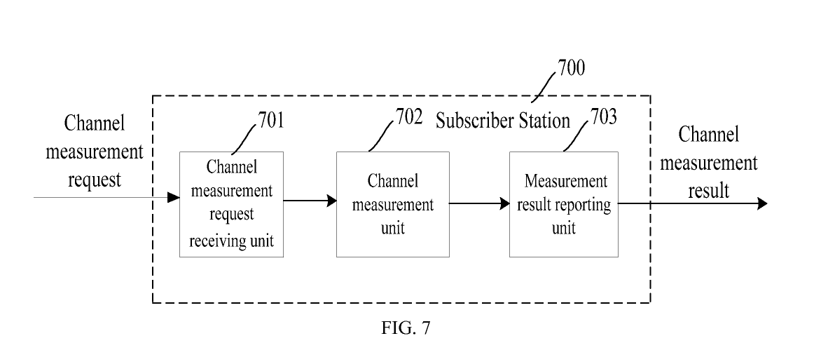

Accordingly, the present invention further provides a subscriber station in wireless broadband access. FIG. 7 is a schematic view of an exemplary structure of the subscriber station, according to an embodiment of the present invention.

As shown in FIG. 7, the subscriber station 700 includes a channel measurement request receiving unit 701, a channel measurement unit 702, and a measurement result reporting unit 703.

The channel measurement request receiving unit 701 is adapted to receive a channel measurement request which includes a channel to be measured and a measurement time.

The channel measurement unit 702 is adapted to measure the channel to be measured within the measurement time.

The measurement result reporting unit 703 is adapted to report the measurement result to the base station.

Preferably, the channel to be measured is a working channel, and the channel measurement unit 702 is adapted to measure the working channel within the measurement time.

Also, the channel to be measured may be a non-working channel, and the channel measurement unit 702 is adapted to switch the subscriber station from the working channel to the non-working channel within the measurement time, and perform a measurement on the non-working channel.

Although the invention being described as some preferred embodiments, the scope for which the protection is sought by the present invention is not limited thereby. Various modifications and variations without departing from the scope or spirit of the invention should be considered falling within the scope of the present invention.

What is claimed is:

1. A method for allocating channel measurement resources in a wireless broadband access, comprising:
receiving, by a subscriber station, a channel measurement request from a base station where the request includes identification of a channel to be measured and a measurement time interval; and
performing a measurement on the channel to be measured within the measurement time interval.

2. The method for allocating channel measurement resources according to claim 1, wherein the channel to be measured is a working channel, and performing the measurement comprises: detecting one of a licensed user and an unlicensed user associated with a non-serving base station.

3. The method for allocating channel measurement resources according to claim 1, wherein the channel to be measured is a non-working channel, and the method further comprises:
switching the subscriber station from a working channel to the non-working channel within the measurement time interval.

4. The method for allocating resource of channel measurement according to claim 3, further comprising pre-setting a maximum channel switching time,
wherein the subscriber station starts the measurement on the non-working channel no later than the maximum channel switching time after the start of the measurement, and terminates the measurement on the non-working channel no later than the maximum channel switching time before the end of the maximum channel switching time.

5. The method for allocating channel measurement resources according to claim 1, further comprising:
reporting actively, by the subscriber station, a measurement result to the base station after the measurement is terminated; or
reporting actively, by the subscriber station, the measurement result to the base station before the measurement is terminated; or
before the subscriber station terminates the measurement, reporting, by the subscriber station, the measurement result to the base station in response to a measurement result request from the base station to the subscriber station; or
after the subscriber station terminates the measurement, reporting, by the subscriber station, the measurement result to the base station in response to a measurement result request from the base station to the subscriber station.

6. The method for allocating channel measurement resources according to claim 1, further comprising at least one of:
terminating, by the subscriber station, the measurement on the channel to be measured;
terminating, by the subscriber station, the measurement in response to the measurement termination request from the base station to the subscriber station; and
according to an instruction of the base station, receiving, by the subscriber station, a downlink signal or transmitting an uplink signal, within the measurement time interval, and terminating the measurement.

7. The method for allocating channel measurement resources according to claim 1, wherein the measurement time interval is preset by the base station according to a measurement purpose and traffics of the subscriber station.

8. The method for allocating channel measurement resources according to claim 1, further comprising:
performing, by the subscriber station, a normal communication with the base station outside the measurement time interval, wherein the measurement time interval has no impact on the normal communication between the subscriber station and the base station.

9. The method for allocating channel measurement resources according to claim 7, wherein the measurement time interval is set within one of a period of a specific subframe and a specific time slot.

10. The method for allocating channel measurement resources according to claim 9, wherein the specific sub frame is a slave sub frame.

11. The method for allocating channel measurement resources according to claim 9, wherein the specific time slot is a coexistence signaling interval time slot, a coexistence massage interval time slot, or a co-existence control channel time slot.

12. The method for allocating channel measurement resources according to claim 9, wherein the measurement time interval is a periodical interval.

13. The method for allocating channel measurement resources according to claim 12, wherein the measurement time interval includes a measurement start frame, a start position and a termination position of a measurement time-frequency block, a measurement duration, and an interval between successive measurement frames, and if the termination position of the measurement time-frequency block is not defined, the default termination position of the measurement time-frequency block is the end of a frame including the measurement time-frequency block.

14. The method for allocating channel measurement resources according to claim 7, wherein the normal communication between the subscriber station and the base station comprises at least one or more normal communications selected from a group of:
adopting a high-order modulation;
reducing an encoding rate;
enhancing a transmit power; and
increasing allocated time-frequency resources.

15. The method for allocating channel measurement resources according to claim 5, wherein the subscriber station indicates that the measurement result is related to the measurement request of the base station.

16. The method for allocating channel measurement resources according to claim 15, wherein the measurement time intervals of two measurement request of the same base station received by the subscriber station do not overlap.

17. The method for allocating channel measurement resources according to claim 15, wherein:
the channel measurement request received by the subscriber station further comprises a channel measurement request index numbered by the base station; and
when reporting the measurement result, the subscriber station further reports the channel measurement request number corresponding to the measurement result to the base station.

18. The method for allocating channel measurement resources according to claim 1, wherein:
the channel measurement request of the subscriber station is set into a request message including at least one additional channel measurement requests of at least one other subscriber station, and the channel measurement request comprises one or more measurement resource allocation schemes.

19. A system for allocating channel measurement resources in a wireless broadband access, comprising a base station:
adapted to transmit a channel measurement request including identification of a channel to be measured and a measurement time interval; and
a subscriber station adapted to receive the channel measurement request, and perform a measurement on the channel within the measurement time interval.

20. The system for allocating channel measurement resources in a wireless broadband access according to claim 19, wherein:
the base station is adapted to set the measurement time interval according to a measurement purpose and traffics of the subscriber station, and transmit the channel measurement request to the subscriber station; and
the subscriber station performs a normal communication with the base station outside the measurement time interval, and the measurement time interval has no impact on the normal communication of the base station and the subscriber station.

21. The system for allocating channel measurement resources in a wireless broadband access according to claim 19, wherein:
the subscriber station is further adapted to report the measurement result to the base station; or
before the subscriber station terminates the measurement, the base station transmits a measurement result report request to the subscriber station, and the subscriber station reports the measurement result to the base station in response to the measurement result report request; or
after the subscriber station terminates the measurement, the base station transmits a measurement result report request to the subscriber station, and the subscriber station reports the measurement result to the base station in response to the measurement result report request.

22. The system for allocating resource of channel measurement in wireless broadband access according to claim 19, wherein the wireless broadband access system is an IEEE 802.16 system or an IEEE 802.22 system.

23. A base station in a wireless broadband access, comprising:
a measurement time setting unit adapted to set measurement time interval during which a subscriber station performs a measurement on a channel according to a measurement purpose and traffics of the subscriber station; and
a channel measurement request transmitting unit adapted to transmit the measurement time interval set by the measurement time setting unit.

24. The base station according to claim 23, further comprising a measurement result receiving unit adapted to receive a measurement result reported by the subscriber station.

25. The base station according to claim 23, wherein the channel measurement request transmitting unit is further adapted to transmit a measurement termination request to the subscriber station.

26. A subscriber station in a wireless broadband access, comprising:
a channel measurement request receiving unit adapted to receive a channel measurement request including identification of a channel to be measured and a measurement time interval; and
a channel measurement unit adapted to perform a measurement on the channel to be measured within the measurement time interval.

27. The subscriber station according to claim 26, wherein:
the channel to be measured is a non-working channel, and the channel measurement unit is adapted to switch the subscriber station from a working channel to the non-working channel and perform a measurement on the non-working channel within the measurement time.

28. The subscriber station according to claim 26, further comprising a measurement result reporting unit adapted to report a measurement result generated within the measurement time interval to the base station.
